(19) United States
(12) Patent Application Publication
(10) Pub. No.: US 2025/0254650 A1
(43) Pub. Date: Aug. 7, 2025

(54) NEGOTIATION FOR COORDINATED TIME DIVISION MULTIPLE ACCESS

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US)

(21) Appl. No.: 19/039,462

(22) Filed: Jan. 28, 2025

Related U.S. Application Data
(60) Provisional application No. 63/549,164, filed on Feb. 2, 2024.

(51) Int. Cl. H04W 64/00; H04L 5/00; H04W 8/22

(52) U.S. Cl. CPC H04W 64/003; H04L 5/0053; H04W 8/22

(57) ABSTRACT

A first access point (AP) in a wireless network, with a memory and a processor coupled to the memory. The processor is configured to cause transmitting, to one or more second APs, a request frame indicating a request for participation in a time division multiple access (TDMA)-based multiple AP (MAP) coordination, wherein the one or more second APs are within a coordination distance of the first AP. The processor is further configured to cause receiving, from at least one second AP, a response frame indicating acceptance of the request for participation in the TDMA-based MAP coordination.

### CROSS REFERENCE TO RELATED APPLICATION

This application claims benefit of U.S. Provisional Application No. 63/549,164, entitled “Negotiation for Coordinated Time Division Multiple Access,” filed on Feb. 2, 2024, in the United States Patent and Trademark Office, the entire contents of which are hereby incorporated by reference.

### TECHNICAL FIELD

This disclosure relates generally to a wireless communication system, and more particularly to, for example, but not limited to, multi-access point (AP) coordination in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and procedure for time division multiple access (TDMA)-based multiple access point (MAP) coordination.

An aspect of the disclosure provides a first access point (AP) in a wireless network. The first AP comprises a memory and a processor coupled to the memory. The processor is configured to cause transmitting, to one or more second APs, a request frame indicating a request for participation in a TDMA-based MAP coordination, wherein the one or more second APs are within a coordination distance of the first AP. The processor is further configured to cause receiving, from at least one second AP, a response frame indicating acceptance of the request for participation in the TDMA-based MAP coordination.

In an embodiment, the request frame includes a mode of coordination indicating a level of coordination that the first AP suggests.

In an embodiment, the response frame includes a mode of coordination indicating a level of coordination that a corresponding second AP supports.

In an embodiment, the response request frame includes a time duration of coordination that the first AP suggests.

In an embodiment, the processor is further configured to cause transmitting, to the one or more second APs, an announcement frame indicating that the first AP intends to initiate the TDMA-based MAP coordination. The processor is further configured to cause receiving, from the one or more second APs, one or more preparedness frames indicating a capability to participate in the TDMA-based MAP coordination.

In an embodiment, each preparedness frame includes a mode of coordination indicating a level of coordination that a corresponding second AP supports.

In an embodiment, a first basic service set (BSS) to which the first AP belongs partially overlaps with one or more second BSSs to which the one or more second APs belong respectively.

An aspect of the disclosure provides an AP in a wireless network. The AP comprises a memory and a processor coupled to the memory. The processor is configured to cause receiving, from a first AP, a request frame indicating that the first AP intends to initiate a TDMA-based MAP coordination with one or more second APs, wherein the one or more second APs are within a coordination distance of the first AP. The processor is further configured to cause transmitting, to the first AP, a response frame indicating an acceptance of the request to initiate the TDMA-based MAP coordination. The processor is further configured to cause transmitting, to the one or more second APs, information frames triggering the one or more second APs to participate in the TDMA-based MAP coordination initiated by the first AP. The processor is further configured to cause receiving, from at least one second AP, an acknowledgement frame indicating that the second AP has received the information frame.

In an embodiment, the request frame includes a mode of coordination indicating a level of coordination that the first AP suggests.

In an embodiment, the response request frame includes a time duration of coordination that the first AP suggests.

In an embodiment, the response frame indicates the acceptance of the request to initiate the TDMA-based MAP coordination based on a status of the wireless network.

In an embodiment, the one or more second APs are determined, by the AP, based on capabilities of the one or more second AP.

In an embodiment, a first BSS to which the first AP belongs partially overlaps with one or more second BSSs to which the one or more second APs belong respectively.

An aspect of the disclosure provides a first AP in a wireless network. The first AP comprises a memory and a processor coupled to the memory. The processor is configured to cause receiving, from a second AP, a request frame indicating a request for participation in a time division multiple access (TDMA)-based multiple AP (MAP) coordination, wherein the first AP is within a coordination distance of the second AP. The processor is further configured to cause transmitting, to the second AP, a response frame indicating acceptance of the request for participation in the TDMA-based MAP coordination.

In an embodiment, the request frame includes a mode of coordination indicating a level of coordination that the second AP suggests.

In an embodiment, the response frame includes a mode of coordination indicating a level of coordination that a corresponding first AP supports.

In an embodiment, the processor is further configured to cause receiving, from the second AP, an announcement frame indicating that the second AP intends to initiate the TDMA-based MAP coordination. The processor is further configured to cause transmitting, to the second AP, a preparedness frame indicating a capability to participate in the TDMA-based MAP coordination.

In an embodiment, the preparedness frame includes a mode of coordination indicating a level of coordination that the first AP supports.

In an embodiment, the processor is further configured to cause receiving, from a third AP, an information frame triggering the first AP to participate in the TDMA-based multiple AP coordination initiated by the second AP. The processor is further configured to cause transmitting, to the third AP, an acknowledgement frame indicating that the first AP has received the information frame.

In an embodiment, a first basic service set (BSS) to which the first AP belongs partially overlaps with one or more second BSSs to which the one or more second APs belong respectively.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of MAP coordination in accordance with an embodiment.

FIG. 5 shows an example architecture for C-TDMA negotiation in accordance with an embodiment.

FIG. 6 shows an example negotiation scenario for TDMA-based MAP coordination in accordance with an embodiment.

FIG. 7 shows another example negotiation scenario for TDMA-based MAP coordination in accordance with an embodiment.

FIG. 8 shows an example process for MAP C-TDMA negotiation in accordance with an embodiment.

FIG. 9 shows another example architecture for MAP C-TDMA negotiation in accordance with an embodiment.

FIG. 10 shows an example negotiation scenario for TDMA-based MAP coordination in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

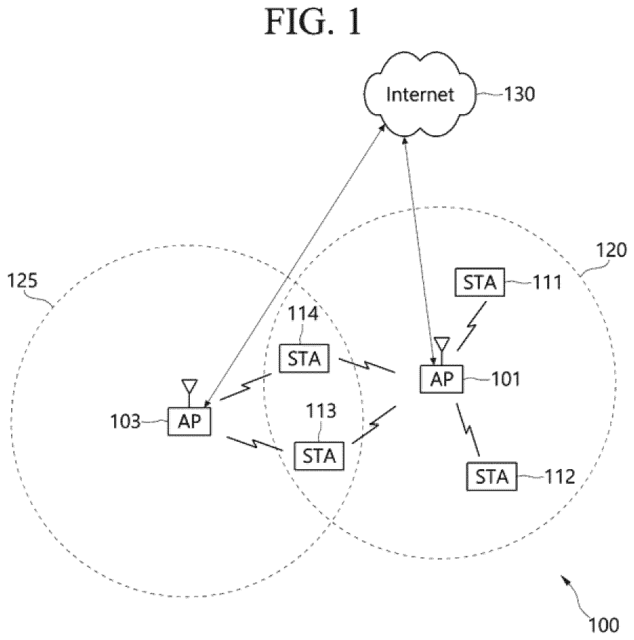

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

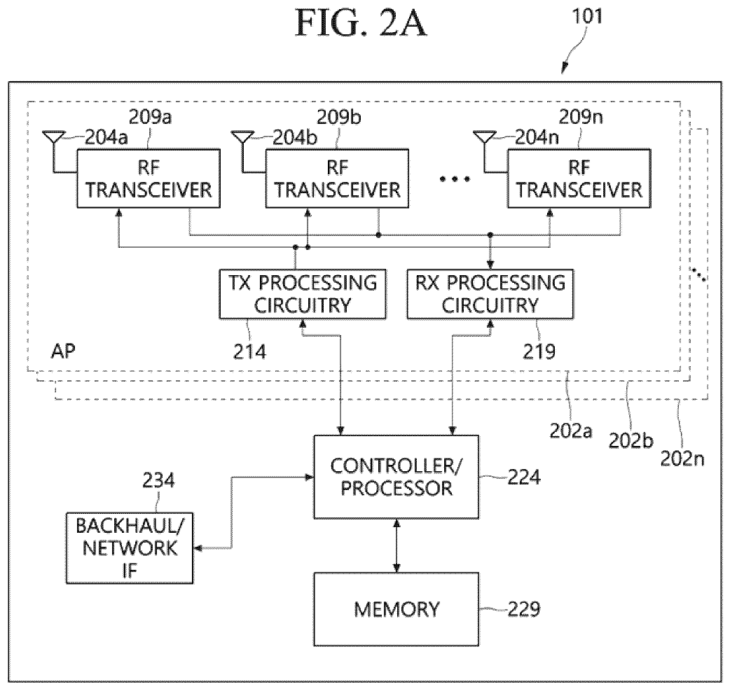

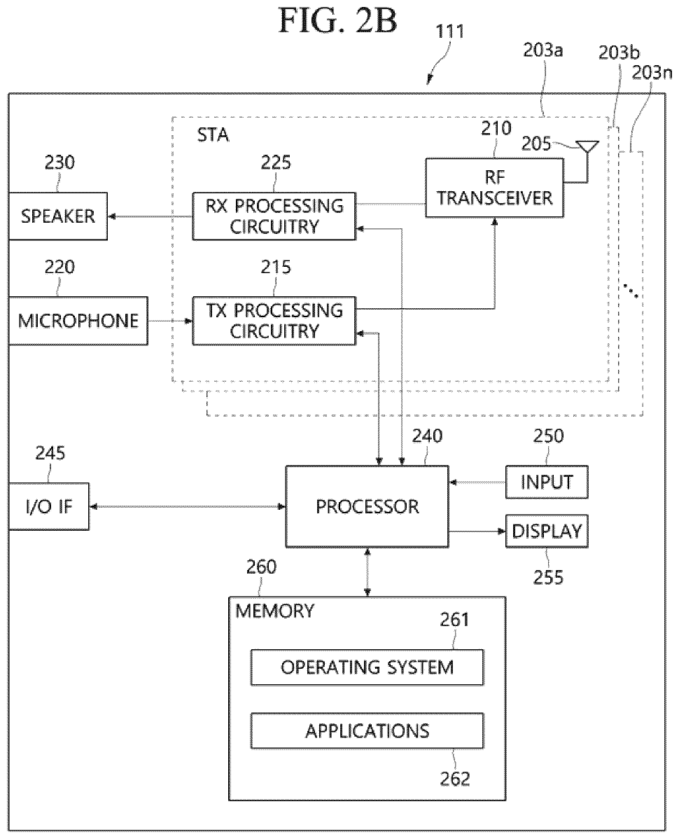

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

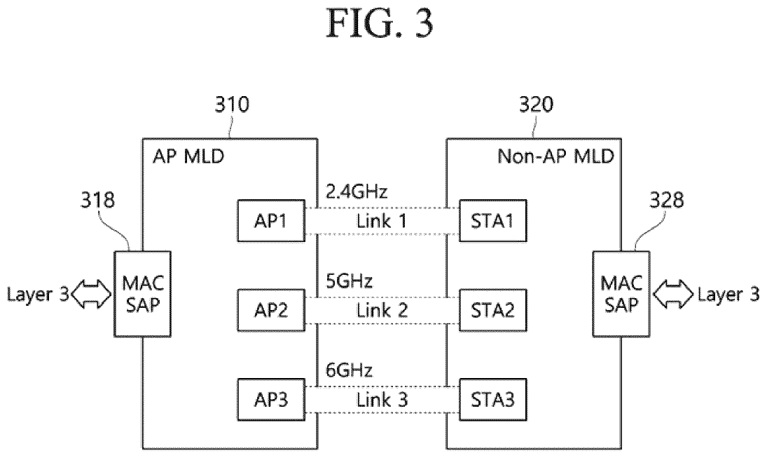

FIGS. 2 and 3 illustrate example electronic devices in accordance with an embodiment of this disclosure. In particular, FIG. 2 shows an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D4.0, “Part 11: Wireless LAN Medium Access Control (MAC) and Physical Layer (PHY) Specifications—Amendment 8: Enhancements for extremely high throughput (EHT).”

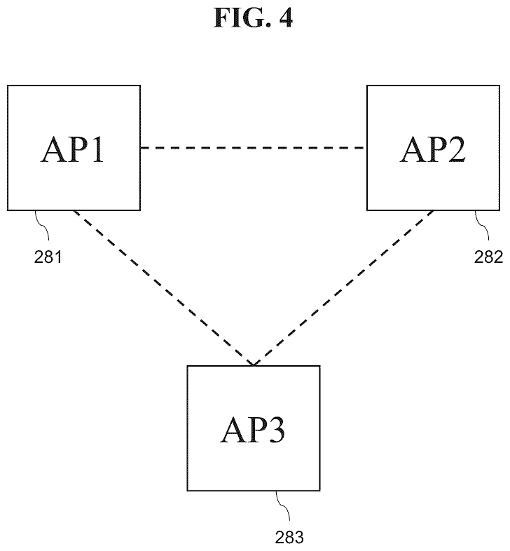

Multi-AP (MAP) coordination is considered as one of the key technologies for the next generation WLAN systems. In MAP coordination, several neighboring APs coordinate with each other for improved network performance as shown in FIG. 4.

FIG. 4 shows an example of MAP coordination in accordance with an embodiment. The MAP coordination depicted in FIG. 4 is for explanatory and illustration purposes. FIG. 4 does not limit the scope of this disclosure to any particular implementation.

As shown in FIG. 4, the MAP coordination may be performed in a group of APs, for example, including AP1, AP2 and AP3. AP1, AP2 and AP3 may coordinate with each other in order to reduce latency resulting from natural overall throughput degradation and/or overlapping basic service set (OBSS) interference. As a result, AP1, AP2 and AP3 improve network performance through MAP coordination.

Interference from one basic service set (BSS) may cause performance issues for STAs and APs in nearby BSSs. This naturally results in overall throughput degradation in the network. The overlapping BSS (OBSS) interference may increase the overall latency since it takes more time to access the channel due to the interference occupying the channel. A delay in channel access may seriously interfere an STA's latency-sensitive applications when the STA is in a nearby BSS and has latency-sensitive traffic. Time Division Multiple Access (TDMA)-based MAP coordination can be an important feature for next generation WLAN network. The disclosure provides various embodiments for negotiation mechanisms and procedure for TDMA-based MAP coordination

In an embodiment, a first AP may coordinate with a second AP in the vicinity such as in a BSS that overlaps with the BSS that the AP resides in. The first AP and the second AP may coordinate on the basis of TDMA. The coordination mechanism may take different formats based on the architecture of the coordinated TDMA (C-TDMA) mechanism.

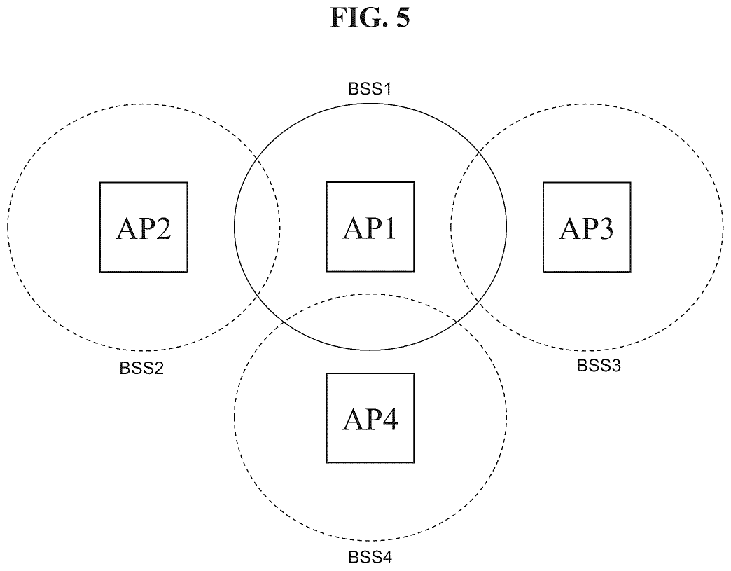

In an embodiment, in an architecture of C-TDMA negotiation (Type-I architecture), the APs participating in the TDMA-based MAP coordination may directly exchange frames within themselves to negotiate on the TDMA-based MAP coordination. An example of Type-I architecture for C-TDMA is illustrated in FIG. 5.

FIG. 5 shows an example architecture for C-TDMA negotiation in accordance with an embodiment. The architecture depicted in FIG. 5 is for explanatory and illustration purposes. FIG. 5 does not limit the scope of this disclosure to any particular implementation.

Referring to FIGS. 5, AP1, AP2, AP 3 and AP4 form BSS1, BSS2, BSS3 and BSS4, respectively. BSS1 partially overlaps with BSS2, BSS3, and BSS4. A group of APs participating in the TDMA-based MAP coordination, including AP1, AP2, AP3 and AP4, directly exchange frames with each other to negotiate on the C-TDMA.

In an embodiment, a first AP intending to participate in a TDMA-based MAP coordination may transmit a C-TDMA request frame to a second AP for TDMA-based MAP coordination. The second AP may be in the vicinity of the first AP. The TDMA-based MAP coordination may be based on Type-I architecture for C-TDMA negotiation. The first AP initiates negotiation for the TDMA-based MAP coordination. The C-TDMA request frame may include various information, including, not limited to, i) the capabilities of the APs participating in the C-TDMA, ii) the time duration of coordination, such as the terms of target beacon transmission time (TBTT) or other terms of time synchronization function (TSF) value, iii) MAP synchronization related information, iv) modes of TDMA-based MAP coordination. The C-TDMA request frame may include information as shown in Table 1.

TABLE 1

| Order | Information |
|---|---|
| 1 | Category |
| 2 | Unprotected S1G Action |
| 3 | Dialog Token |
| 4 | MAP TDMA Coordination Mode |
| 5 | MAP Capabilities Information |

Referring to Table 1, the C-TDMA request frame includes a Category field, a Unprotected SIG Action, a Dialog Token field, a MAP TDMA Coordination Mode field and a MAP Capabilities Information field. The Category field indicates an action frame category associated with the C-TDMA request frame. The Unprotected SIG Action field indicates an Unprotected SIG category associated with the C-TDMA request frame. The Dialog Token field includes information to identify the C-TDMA request/response transaction. The MAP TDMA Coordination Mode field indicates the degree of coordination. The MAP Capabilities Information field indicates information regarding the capabilities of the MAP.

In an embodiment, the second AP may transmit, to the first AP, a C-TDMA response frame indicating the response to a received C-TDMA request after receiving the request frame from the first AP. The first AP and the second AP enter into the C-TDMA phase when the second AP indicates acceptance of the C-TDMA request. A possible format of the C-TDMA response frame is shown in Table 2.

TABLE 2

| Order | Information |
|---|---|
| 1 | Category |
| 2 | Unprotected S1G Action |
| 3 | Dialog Token |
| 4 | MAP TDMA Coordination Mode |
| 5 | MAP Capabilities Information |

Referring to Table 2, the C-TDMA request frame includes a Category field, a Unprotected S1G Action, a Dialog Token field, a MAP TDMA Coordination Mode field and a MAP Capabilities Information field. The Category field indicates an action frame category associated with the C-TDMA request frame. The Unprotected SIG Action field indicates an Unprotected SIG category associated with the C-TDMA request frame. The Dialog Token field includes information to identify the C-TDMA request/response transaction. The MAP TDMA Coordination Mode field indicates the degree of coordination. The MAP Capabilities Information field indicates information regarding the capabilities of the MAP.

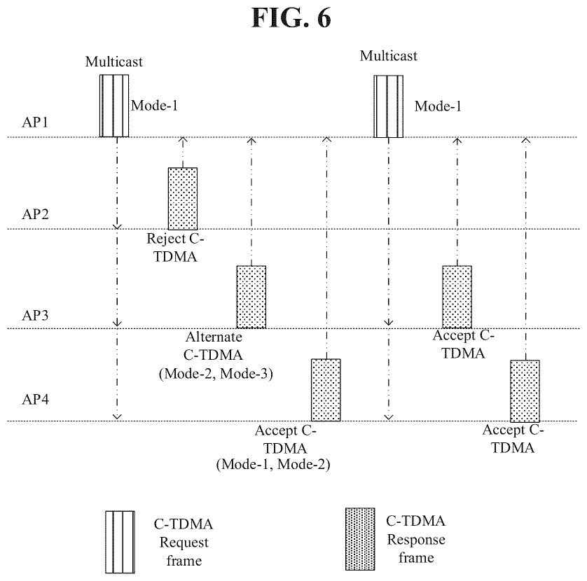

FIG. 6 shows an example negotiation scenario for TDMA-based MAP coordination in accordance with an embodiment. The scenario depicted in FIG. 6 is for explanatory and illustration purposes. FIG. 6 does not limit the scope of this disclosure to any particular implementation.

Referring to FIG. 6, the example scenario involves the participation of AP1, AP2, AP3 and AP4. AP1 transmits, to AP2, AP3 and AP4, a first C-TDMA request frame indicating Mode-1 via multicast. In response, AP2 transmits, to AP1, a C-TDMA response frame indicating that AP2 rejects the first C-TDMA request. AP3 transmits, to AP1, a C-TDMA response frame indicating an alternate C-TDMA indicating Mode-2 and Mode-3. AP4 transmits, to AP1, a C-TDMA response frame indicating that AP4 accepts the first C-TDMA request indicating Mode-1 and Mode-2. Subsequently, AP1 transmits, to AP3 and AP4, a second C-TDMA request frame indicating Mode-1 via multicast. In response, AP3 transmits, to AP1, a C-TDMA response frame indicating that AP3 accepts the second C-TDMA request on Mode-1. AP4 transmits, to AP1, a C-TDMA response frame indicating that AP4 accepts the second C-TDMA request on Mode-1. The different modes may represent different degrees of TDMA-based MAP coordination. Mode-1 may indicate a greater degree of coordination than Mode-2. Mode-2 may indicate a greater degree of coordination than Mode-3 but a lesser degree of coordination than Mode-1.

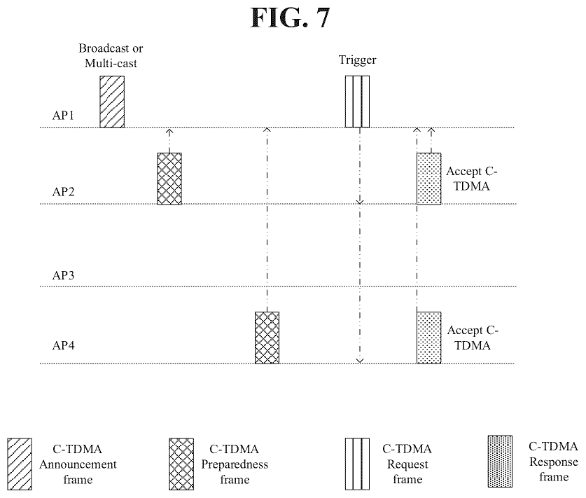

In an embodiment, two or more APs may enter an announcement phase that precedes active negotiations between the two or more APs in the architecture for C-TDMA negotiation shown in FIG. 5. A first AP that intends to initiate TDMA-based MAP coordination with other APs may first transmit a C-TDMA announcement frame to identify the APs in its neighborhood that are willing to participate in TDMA-based MAP coordination. The second AP may transmit a C-TDMA preparedness frame to the first AP indicating its capability to participate in the TDMA-based MAP coordination, after receiving the C-TDMA announcement frame from the first AP. The second AP may indicate, in the C-TDMA preparedness frame, the Modes of coordination that the second AP supports in the second AP's BSS. A possible scenario for TDMA-based MAP coordination where the C-TDMA negotiation phase is preceded by a C-TDMA announcement frame by the AP as shown in FIG. 7.

FIG. 7 shows another example negotiation scenario for TDMA-based MAP coordination in accordance with an embodiment. The scenario depicted in FIG. 7 is for explanatory and illustration purposes. FIG. 7 does not limit the scope of this disclosure to any particular implementation.

Referring to FIG. 7, the example scenario involves the participation of AP1, AP2 and AP4. AP1 transmits, to AP2, AP3 and AP4, a C-TDMA announcement frame via multicast. AP1 may, alternatively, broadcast the C-TDMA announcement frame. In response, AP2 transmits, to AP1, a C-TDMA preparedness frame indicating that AP2 is willing to participate in TDMA-based MAP coordination. AP3 does not respond to the C-TDMA announcement frame, for example and without limitation, indicating that AP3 is unwilling to participate in TDMA-based MAP coordination. AP4 transmits, to AP1, a C-TDMA preparedness frame indicating that AP4 is willing to participate in TDMA-based MAP coordination. Subsequently, AP1 transmits, to AP2 and AP4, a C-TDMA request frame. In response, AP2 and AP4 transmit, to AP1, a C-TDMA response frame, respectively, indicating that AP2 and AP4 accept the C-TDMA request. In an embodiment, AP2 and AP4 may transmit the C-TDMA response frame at the same time in response to the C-TDMA request frame.

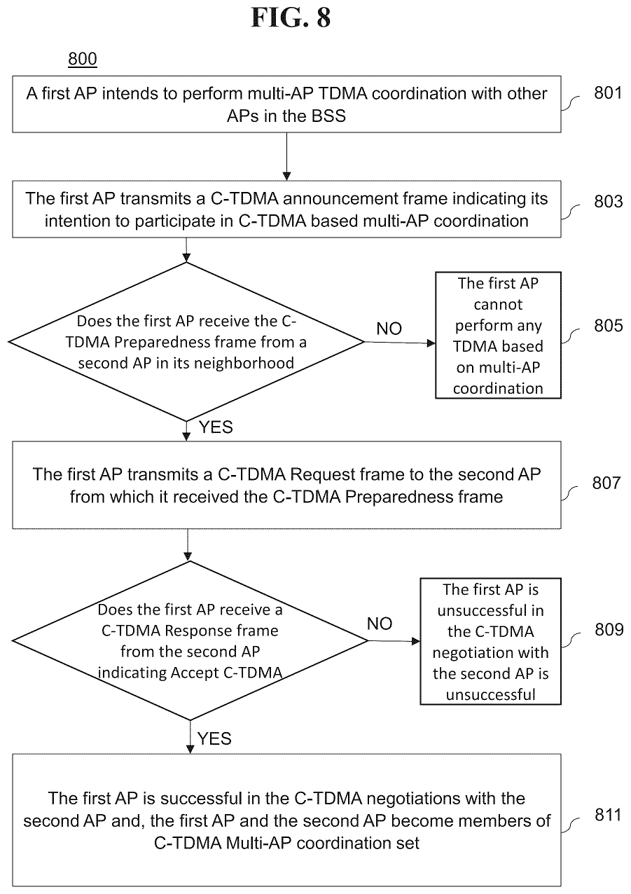

FIG. 8 shows an example process 800 for MAP C-TDMA negotiation in accordance with an embodiment. The process depicted in FIG. 8 is for explanatory and illustration purposes. FIG. 8 does not limit the scope of this disclosure to any particular implementation.

Referring to FIG. 8, the process 800 begins at operation 801. In operation 801, a first AP intends to perform TDMA-based MAP coordination with other APs in the BSS.

In operation 803, the first AP transmits a C-TDMA announcement frame indicating its intention to participate in TDMA-based MAP coordination. The C-TDMA announcement frame may be transmitted in a broadcast frame, a multicast frame or a unicast frame. Operation 803 is followed by operation 805 when the AP doesn't receive the C-TDMA preparedness frame from a second AP in the neighborhood. Operation 803 is followed by operation 807 when the AP did receive the C-TDMA preparedness frame from the second AP in its neighborhood.

In operation 805, the first AP may not perform any TDMA-based MAP coordination.

In operation 807, the first AP transmits a C-TDMA request frame to the second AP from which it received the C-TDMA preparedness frame. The C-TDMA request frame may include a trigger frame. Operation 807 is followed by operation 809 when the first AP doesn't receive a C-TDMA response frame from the second AP indicating Accept C-TDMA. Operation 807 is followed by operation 811 when the first AP receives a C-TDMA response frame from the second AP indicating Accept C-TDMA.

In operation 809, the first AP is unsuccessful in the C-TDMA negotiations with the second AP.

In operation 811, the first AP is successful in the C-TDMA negotiations with the second AP, and the first AP and the second AP become members of a MAP C-TDMA coordination set.

A possible format of the C-TDMA announcement frame as shown in Table 3.

TABLE 3

| Order | Information |
|---|---|
| 1 | Category |
| 2 | TDMA Coordination Mode |
| 3 | MAP Capabilities Information |

Referring to Table 3, the C-TDMA announcement frame includes a Category field, a TDMA Coordination Mode field and MAP Capabilities Information field. The Category field indicates an action frame category associated with the C-TDMA request frame. The TDMA Coordination Mode field indicates the degree of coordination. The MAP Capabilities Information field indicates information regarding the capabilities of the MAP.

A possible format of the C-TDMA preparedness frame is shown in Table 4.

TABLE 4

| Order | Information |
|---|---|
| 1 | Category |
| 2 | Unprotected S1G Action |
| 3 | TDMA Coordination Mode |
| 4 | MAP Capabilities Information |

Referring to Table 4, the C-TDMA announcement frame includes a Category field, an Unprotected SIG Action field, a TDMA Coordination Mode field and MAP Capabilities Information field. The Category field indicates an action frame category associated with the C-TDMA request frame. The Unprotected SIG Action field indicates an Unprotected SIG category associated with the C-TDMA request frame. The TDMA Coordination Mode field indicates the degree of coordination. The MAP Capabilities Information field indicates information regarding what the MAP are capable of.

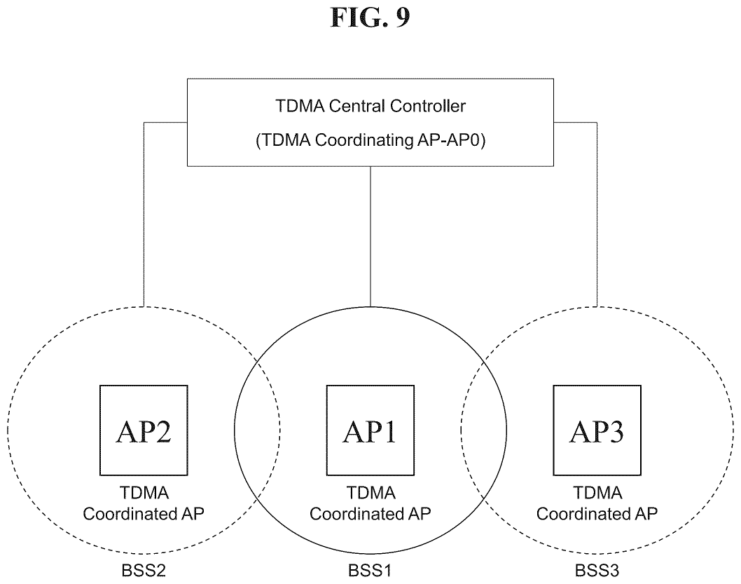

In an embodiment, in an architecture of C-TDMA negotiation (Type-II architecture), the AP's C-TDMA negotiations may be controlled by a C-TDMA central controller. The C-TDMA central controller may perform the C-TDMA negotiations. An example of Type-II architecture for C-TDMA is illustrated in FIG. 9.

FIG. 9 shows another example architecture for MAP C-TDMA negotiation in accordance with an embodiment. The architecture depicted in FIG. 9 is for explanatory and illustration purposes. FIG. 9 does not limit the scope of this disclosure to any particular implementation.

Referring to FIGS. 9, AP1, AP2 and AP3 form BSS1, BSS2 and BSS3, respectively. BSS1 partially overlaps with BSS2 and BSS3. A group of APs participating in the TDMA-based MAP coordination, including AP1, AP2 and AP3, are coordinated by a C-TDMA Central Controller.

In an embodiment, in Type-II architecture for C-TDMA negotiation, a first AP intends to initiate the TDMA-based MAP coordination with other APs. The first AP may transmit a C-TDMA request frame to the C-TDMA Central Controller. The C-TDMA Central Controller may have C-TDMA schedules of all APs that are connected with the controller. The C-TDMA Central Controller may transmit a response frame to the first AP based on the overall network situation, upon receiving the C-TDMA coordination request frame from the first AP. The C-TDMA Central Controller may transmit a C-TDMA coordination information frame to other APs when the C-TDMA Central Controller accepts the coordination request. The C-TDMA Central Controller may transmit the C-TDMA coordination information frame to APs that the controller finds suitable for coordination. The C-TDMA Central Controller may trigger the APs to participate in the TDMA-based MAP coordination initiated by the first AP. Subsequently, the APs that receive a C-TDMA coordination information frame from the C-TDMA Central Controller may transmit a C-TDMA coordination acknowledgement frame to the C-TDMA Central Controller as an acknowledgement for the reception.

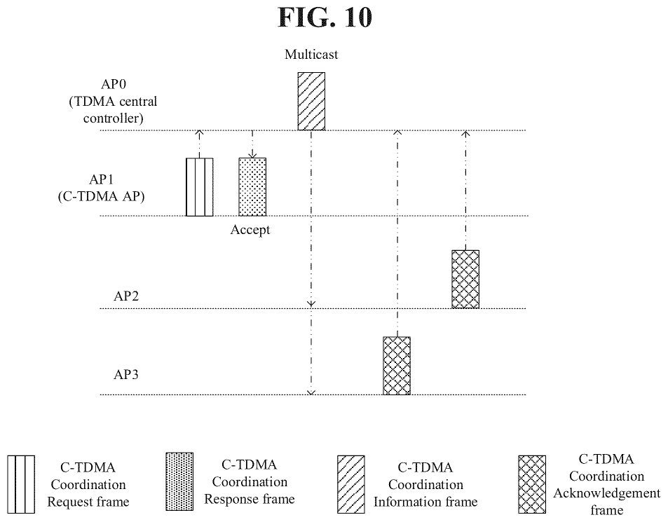

FIG. 10 shows an example negotiation scenario for TDMA-based MAP coordination in accordance with an embodiment. The mechanism depicted in FIG. 10 is for explanatory and illustration purposes. FIG. 10 does not limit the scope of this disclosure to any particular implementation.

Referring to FIG. 10, AP1 transmits, to AP0, a C-TDMA coordination request frame. In response, AP0 transmits, to AP1, a C-TDMA coordination response frame indicating that AP0 accepts the C-TDMA coordination request. Subsequently, AP0 transmits, to AP2 and AP3, a C-TDMA coordination information frame via multicast. In response, AP3 transmits, to AP0, a C-TDMA coordination acknowledgement frame. AP2 transmits, to AP0, a C-TDMA coordination acknowledgement frame.

The disclosure provides mechanisms and procedures for TDMA-based MAP coordination, such as decentralized AP coordination where a group of APs coordinate with each other or centralized AP coordination where there is a C-TDMA Central Controller coordinating other APs.

According to various embodiments, a first STA requests, from an AP, a resource on behalf of a second STA so that AP will be able to efficiently allocate time (or TXOP) of the pending traffic from the first STA to the second or from the second STA to the first STA in their P2P communication, so that latency sensitive traffic may be delivered in a timely manner.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, comprising:
a memory; and
a processor coupled to the memory, the processor configured to cause:
transmitting, to one or more second APs, a request frame indicating a request for participation in a time division multiple access (TDMA)-based multiple AP (MAP) coordination, wherein the one or more second APs are within a coordination distance of the first AP; and
receiving, from at least one second AP, a response frame indicating acceptance of the request for participation in the TDMA-based MAP coordination.

2. The first AP of claim 1, wherein the request frame includes a mode of coordination indicating a level of coordination that the first AP suggests.

3. The first AP of claim 1, wherein the response frame includes a mode of coordination indicating a level of coordination that a corresponding second AP supports.

4. The first AP of claim 1, wherein the response request frame includes a time duration of coordination that the first AP suggests.

5. The first AP of claim 1, the processor is further configured to cause:
transmitting, to the one or more second APs, an announcement frame indicating that the first AP intends to initiate the TDMA-based MAP coordination; and
receiving, from the one or more second APs, one or more preparedness frames indicating a capability to participate in the TDMA-based MAP coordination.

6. The first AP of claim 5, wherein each preparedness frame includes a mode of coordination indicating a level of coordination that a corresponding second AP supports.

7. The first AP of claim 1, wherein a first basic service set (BSS) to which the first AP belongs partially overlaps with one or more second BSSs to which the one or more second APs belong respectively.

8. An access point (AP) in a wireless network, comprising:
a memory; and
a processor coupled to the memory, the processor configured to cause:
receiving, from a first AP, a request frame indicating that the first AP intends to initiate a time division multiple access (TDMA)-based multiple AP (MAP) coordination with one or more second APs, wherein the one or more second APs are within a coordination distance of the first AP;
transmitting, to the first AP, a response frame indicating an acceptance of the request to initiate the TDMA-based MAP coordination;
transmitting, to the one or more second APs, information frames triggering the one or more second APs to participate in the TDMA-based MAP coordination initiated by the first AP; and
receiving, from at least one second AP, an acknowledgement frame indicating that the second AP has received the information frame.

9. The AP of claim 8, wherein the request frame includes a mode of coordination indicating a level of coordination that the first AP suggests.

10. The AP of claim 8, wherein the response request frame includes a time duration of coordination that the first AP suggests.

11. The AP of claim 8, wherein the response frame indicates the acceptance of the request to initiate the TDMA-based MAP coordination based on a status of the wireless network.

12. The AP of claim 8, wherein the one or more second APs are determined, by the AP, based on capabilities of the one or more second AP.

13. The AP of claim 8, wherein a first basic service set (BSS) to which the first AP belongs partially overlaps with one or more second BSSs to which the one or more second APs belong respectively.

14. A first access point (AP) in a wireless network, comprising:
a memory; and
a processor coupled to the memory, the processor configured to cause:
receiving, from a second AP, a request frame indicating a request for participation in a time division multiple access (TDMA)-based multiple AP (MAP) coordination, wherein the first AP is within a coordination distance of the second AP; and
transmitting, to the second AP, a response frame indicating acceptance of the request for participation in the TDMA-based MAP coordination.

15. The first AP of claim 14, wherein the request frame includes a mode of coordination indicating a level of coordination that the second AP suggests.

16. The first AP of claim 14, wherein the response frame includes a mode of coordination indicating a level of coordination that a corresponding first AP supports.

17. The first AP of claim 14, wherein the processor is further configured to cause:
receiving, from the second AP, an announcement frame indicating that the second AP intends to initiate the TDMA-based MAP coordination; and
transmitting, to the second AP, a preparedness frame indicating a capability to participate in the TDMA-based MAP coordination.

18. The first AP of claim 17, wherein the preparedness frame includes a mode of coordination indicating a level of coordination that the first AP supports.

19. The first AP of claim 14, wherein the processor is further configured to cause:
receiving, from a third AP, an information frame triggering the first AP to participate in the TDMA-based multiple AP coordination initiated by the second AP; and
transmitting, to the third AP, an acknowledgement frame indicating that the first AP has received the information frame.

20. The first AP of claim 14, wherein a first basic service set (BSS) to which the first AP belongs partially overlaps with one or more second BSSs to which the one or more second APs belong respectively.
